(19) United States
(12) Patent Application Publication
(10) Pub. No.: US 2012/0054370 A1
(43) Pub. Date: Mar. 1, 2012

(54) DATA FILE TRANSFER APPARATUS AND CONTROL METHOD OF THE DATA FILE TRANSFER APPARATUS

(75) Inventor: Kazuyuki Tsubakihara, Kawasaki-shi (JP)

(73) Assignee: CANON KABUSHIKI KAISHA, Tokyo (JP)

(21) Appl. No.: 13/206,918

(22) Filed: Aug. 10, 2011

(30) Foreign Application Priority Data
Sep. 1, 2010 (JP) 2010-196096

(51) Int. Cl. G06F 15/16

(52) U.S. Cl. 709/246

(57) ABSTRACT

While storing and managing moving picture data that cannot be reproduced unless data of an entire file is included, the present invention enables a request source apparatus to reproduce the file without waiting for the reception of the end of the file and then transfers the file. To this end, all storage addresses of chunks managed by a moov atom are increased by the size of the moov atom to generate a new moov atom when a transfer request of a moving picture file, which is arranged in the order of an ftype atom, an mdat atom, and the moov atom, is received. A file, which is arranged in the order of the ftype atom, the generated new moov atom, and the mdat atom, is transferred to the request source.

### BACKGROUND OF THE INVENTION

1. Field of the Invention

The present invention relates to a data file transfer technique for holding media files, such as moving picture files and music files, in a recording medium and transferring a desired media file to another device or medium in response to a request.

2. Description of the Related Art

In recent years, apparatuses that record moving pictures in recording media as digital data files (media files) are widely used. Some of the apparatuses have a function of transferring a media file recorded in a recording medium to another terminal (such as a computer, a recording device, and a reproduction device) or recording medium. Examples of known file formats suitable for media files include a MOV format and an MP4 format. In the MOV format and the MP4 format, management information and media data are stored in one file, and the information and the data can be handled as a single file. The formats have a high affinity for personal computer (PC). The MOV format and the MP4 format have similar file formats. Hereinafter, a file in the MOV format (MOV file) will be described, and the description of the MP4 format will be skipped.

In the MOV file, all data is packed in data structures called “atoms” (or “boxes”) and recorded. Each atom has a data structure defined as follows.

class Atom {

unsigned int(32) size;
byte type[4];
byte data[ ];

};

The field (or member) “size” is a field indicating the data length (bit count) of the atom. The field “type” is a field indicating the type of the atom, and an identifier of four letters allocated to each atom is set. The fields “size” and “type” form the header section of the atom. The field “data” denotes the substance (payload section) of the data included in the atom, and the content varies depending on the field “type”. The atoms can form a nest structure and can include one or more other atoms. Therefore, the field “data” may be another atom.

The atoms included in the MOV file are roughly classified into three atoms. The first is an atom of an ftype type (identifier of the type field is “ftyp”), which records information related to compatibility. A reproduction device can reference the ftype to roughly determine whether the file is compatible with the reproduction. The second is an atom of an mdat type (identifier of the type field is “mdat”) in which media data of moving pictures, sound, etc., include tiny continuous encoded data (hereinafter, referred to as “samples”) divided by the duration or frame. The third is an atom of a moov type (identifier of the field “type” is “moov”) which includes management information, such as encoding formats and sizes of the samples, recording positions in the file, and time stamps.

The media data of the mdat atom is logically divided into data blocks called “chunks” and stored. Each chunk includes temporally continuous sample data, and the field “data” of the mdat atom stores an array of chunks. The sizes of the chunks and the numbers of samples are not particularly limited. Chunks in arbitrary sizes and numbers of samples can be included and stored.

Recording positions of the mdat atom and the moov atom in the MOV format file are not defined. The atoms may be stored in the order of the mdat atom and the moov atom, or may be recorded in the order of the moov atom and the mdat atom. However, in the recording of moving pictures taken by an image sensing apparatus, such as a digital camera, as a MOV file, the ultimate length of the recording time is not known until the end of the recording. The sizes of the mdat atom and the moov atom managing the mdat atom increase as the recording time increases. More specifically, the ultimate sizes of the atoms are determined at the end of the recording, and the file cannot be formed in the middle of the recording. Therefore, the moov atom in a small data size is held in a work memory during imaging. The mdat atom in a large data size is sequentially added behind ftype, and after the recording of mdat after the completion of imaging, the moov atom held in the work memory is added behind the mdat atom to form a MOV file in a typical recording method. Therefore, it is desirable that the sequence of the atoms when the digital camera takes moving pictures to form a MOV format file is ftype→mdat→moov for efficiency.

Meanwhile, a reproduction device that reproduces the MOV file recorded in the order of ftype→mdat→moov will be considered. In this case, a process of looking ahead moov of the management information recorded at the end of the file is necessary at the start of the reproduction. This is because unless the moov atom is referenced, the chunk positions of individual frame images and audio data cannot be recognized, and the start position of the reproduction is unclear. Particularly, this can be easily understood by considering a case, in which the reproduction device receives and reproduces a MOV format file held in an external device using file transfer. In this case, it is inconvenient that the reproduction device cannot start the reproduction unless the stored file of moov is received up to the end. In general, the size of a moving picture file is large, and much time is necessary before the completion of the file transfer. Therefore, the problem cannot be ignored. In view of the point, Japanese Patent Laid-Open No. 2005-65110 proposes a file recording method for recording in the order of ftype, moov, and mdat by disposing moov in front of mdat in recording by an image sensing apparatus.

In the file recording method shown in the document, a process of moving data already recorded in a file to the backside of the file may be generated in real-time recording of moving picture data. The process of moving a part of the data is usually a process with a long processing time. Particularly, when a flash memory recently used as a recording medium is used, a process of seeking back and forth inside the file before writing may require a significantly long processing time due to the recording characteristics. The real-time recording of the imaged data cannot keep the pace if the processing time of the data moving process is significantly long, and the recording may have to be suspended.

### SUMMARY OF THE INVENTION

In view of these circumstances, a data file transfer apparatus of the present invention provides a technique of reconfiguring a MOV file, which records atoms (or boxes) in the order of ftype, mdat, and moov, into a format convenient for the receiver before transferring the MOV file.

To solve the problems, for example, the present invention provides a data file transfer apparatus including: a communication unit that communicates with an external apparatus; a storage unit that stores a moving picture file in a predetermined data structure, the file including a data portion with a structure of connected chunk data indicated by partially encoded data and including a management information portion that follows the data portion and indicates a reproduction order and storage addresses of the chunk data; a reception unit that receives a transfer request of the moving picture file stored in the storage unit from the external apparatus through the communication unit; and a transfer unit that transfers the moving picture file, which is reconfigured by interchanging the order of the data portion and the management information portion in the moving picture file requested for the transfer, to the external apparatus through the communication unit when the reception unit receives the transfer request, wherein the transfer unit includes: a generating unit that generates a new management information portion by adding an offset corresponding to a size of the management information portion to the storage addresses of the chunk data stored in the management information portion in the moving picture file requested for the transfer; and a sending unit that sends, as the management information portion in the moving picture file requested for the transfer, the new management information portion generated by the generating unit to the external apparatus and then sends the data portion.

According to the present invention, while moving picture data that cannot be reproduced without waiting for data of the entire file is stored and managed, moving pictures can be reproduced without a request source apparatus waiting for the reception of the end of the file.

Further features of the present invention will become apparent from the following description of exemplary embodiments (with reference to the attached drawings).

### BRIEF DESCRIPTION OF THE DRAWINGS

FIG. 1 is a diagram showing an example of configuration of an image sensing apparatus of a first embodiment;

FIGS. 2A and 2B are diagrams showing MOV file configurations;

FIG. 3 is a flow chart showing a file transfer process of the first embodiment;

FIG. 4 is a flow chart showing an atom interchange transfer process;

FIG. 5 is a diagram showing a file reading transfer order;

FIG. 6 is a diagram showing an example of configuration of the image sensing apparatus of a second embodiment;

FIG. 7 is a flow chart showing a basic process of the image sensing apparatus;

FIG. 8 is a diagram showing a management table of a third embodiment; and

FIG. 9 is a flow chart showing a file transfer process of the third embodiment.

### DESCRIPTION OF THE EMBODIMENTS

Hereinafter, embodiments according to the present invention will be described in detail with reference to the appended drawings. The embodiments described below are examples for realizing the present invention. The embodiments are appropriately corrected or changed based on the configurations of apparatuses, to which the present invention is applied, and various conditions. The present invention is not limited to the following embodiments. The embodiments are applied to an image sensing apparatus, represented by a digital camera, as a data file transfer apparatus in the examples described below.

### First Embodiment

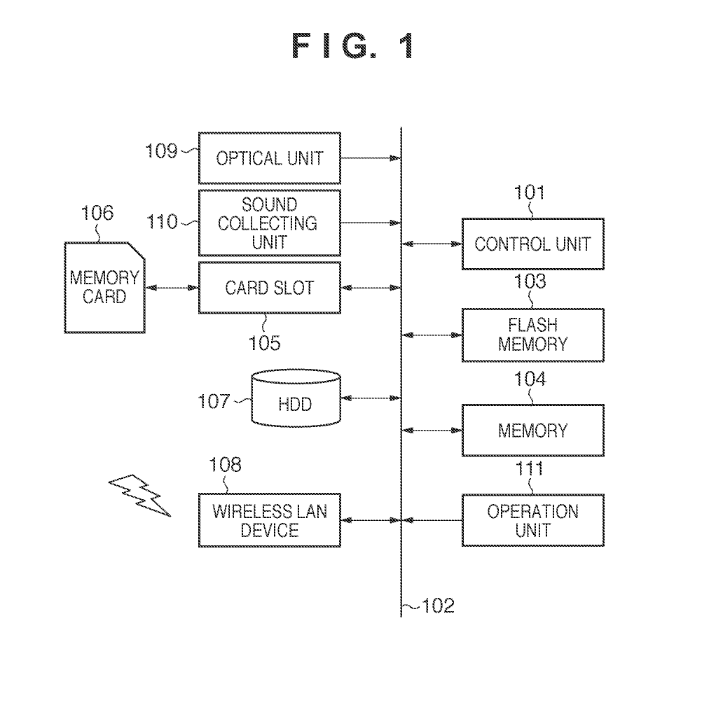

FIG. 1 shows a block diagram of an image sensing apparatus of a first embodiment. As shown in FIG. 1, the apparatus includes a control unit 101, a bus 102, a flash memory 103, a memory 104, a card slot 105, an HDD 107, a wireless LAN device 108, an optical unit 109, a sound collecting unit 110, and an operation unit 111.

The control unit 101 is a controller that controls the entire image sensing apparatus. The control unit 101 includes a processor, such as a CPU, that executes an encoding/decoding processes, a file transfer process described later, various communication protocol processes for file transfer, a file system process, etc. The control unit 101 further executes processing related to data transfer between the constituent elements via the bus 102. The flash memory 103 stores programs operated by the control unit 101 and various setting data, and the programs and the data are held even if the power of the apparatus is turned off. The memory 104 is a so-called RAM which serves as a work memory of the control unit 101 or a buffer in the data transfer between blocks. The card slot 105 is for connecting the removable memory card 106. The memory card 106 is initialized by a predetermined file system and is used to store and hold photographed still image files and moving picture files. A predetermined file system is established in the HDD (Hard Disc Drive) 107 as in the memory card 106, and the HDD 107 is used to store and hold the photographed still image files and moving picture files. The card slot 105 and the HDD 107 are not essential, as long as there is one or more recording media. The optical unit 109 includes image sensing elements, such as a lens, a CCD, and a CMOS, and an A/D converter that converts an imaged video signal to digital image data and is configured to take still images and moving pictures. The sound collecting unit 110 includes a microphone, an amplifier that amplifies an audio signal detected by the microphone, and an A/D converter that converts the amplified audio signal to digital data. The operation unit 111 includes a display that functions as a user interface. The operation unit 111 further includes a shutter button for still image photographing, a button for instructing start/end of moving picture photographing, a switch for causing the apparatus to function as a file server on the network, and various other switches and buttons. When the user operates the operation unit 111 to cause the apparatus to function as a file server, the apparatus functions as a media server on the network. The apparatus transfers still image files and moving picture files stored in the memory card 106 and the HDD 107 in response to a request from a client (receiver) on the network through the wireless LAN device 108. The transfer protocol may be an FTP (File Transfer Protocol) or may be other protocols. In an apparatus including a plurality of card slots, a wireless LAN card may be inserted into one of the card slots to constitute the wireless LAN device 108.

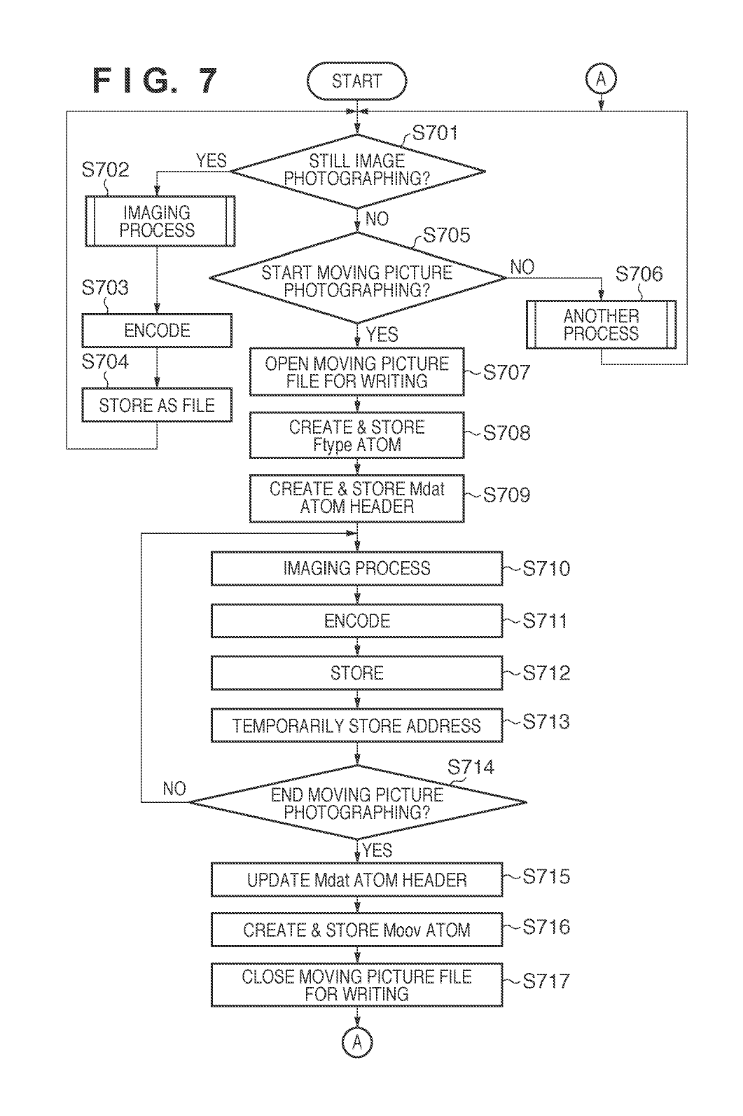

Based on the configuration, the procedure of a process executed by the control unit 101 of the apparatus will be described in accordance with a flow chart of FIG. 7. As described above, the program corresponding to the flow chart of FIG. 7 is stored in the flash memory 103, and the control unit 101 executes the program.

The control unit 101 first determines whether still image photographing is instructed by the operation unit 111, i.e., whether a still image shutter button is operated (S701). If an input of the still image photographing instruction is detected, the control unit 101 controls the optical unit 109 to take a still image and obtains digital image data (S702). The control unit 101 encodes the digital image data (S703), stores the encoded data in the memory card 106 or the HDD 107 as a still image file (S704), and returns to S701.

If the input of instruction from the operation unit 111 is not the still image photographing instruction (S701), the control unit 101 determines whether a start instruction of moving picture photographing is inputted (S705). If the control unit 101 determines that the instruction is not the start instruction of moving picture photographing, the control unit executes processes corresponding to the inputted instruction (S706). One of the processes of S706 is a process of causing the image sensing apparatus to function as a file server described later. When the start instruction of moving picture photographing is received, the image sensing apparatus of the present embodiment can convert the photographed moving pictures to a moving picture file in the MOV format or the MP4 format and record the file. The management information and the media data are stored in one file in the MOV format and the MP4 format, and the information and the data can be handled as a single file. Therefore, the formats have high affinity for personal computer (PC). The MOV and MP4 formats have very similar file structures. Although an example of a case of file recording in the MOV format (MOV file) will be described below, a case of file recording in the MP4 format (MP4 file) can be similarly realized.

If the control unit 101 determines that the start instruction of moving picture photographing is inputted, the control unit 101 opens, in the HDD 107 (may be the memory card 106), a moving picture file in the MOV format for writing (S707). Subsequently, the control unit 101 creates an ftype atom and stores the created ftype atom at the top of the opened moving picture file for writing (S708). The control unit 101 creates a header section of an mdat atom and stores the header section at a position following the ftype atom (S709). However, the field “size” in the header section of the mdat atom is unclear at this time, and the control unit 101 leaves the part blank. As a result, the file of moving pictures is prepared. The control unit 101 causes the optical unit 109 to execute a moving picture imaging process and causes the sound collecting unit 110 to execute a sound detection process (S710). As a result, images are stored in the memory 104 frame by frame, and audio data is also stored in the memory 104 at the same time. Therefore, the control unit 101 encodes the images and the audio data (S711) and sequentially stores, as chunks, the encoded data at positions following the header section of the mdat atom (S712). At this time, the storage positions of the chunks from the top of the file become clear, and the control unit 101 temporarily stores the address positions in the memory 104 (S713). The reason for storing the address positions is to generate a moov atom when the moving picture photographing is finished. The process is repeated until the user instructs the end of the moving picture photographing from the operation unit 111. Therefore, an mdat atom as connected data portions of chunk data of partially encoded data will be established.

If the control unit 101 detects the end instruction of moving picture photographing (S714), the size of the mdat atom is determined. Therefore, the control unit 101 writes a bit count indicating the size of the mdat atom in the field “size” at the header section of the mdat atom (S715). The control unit 101 then creates a moov atom as a management information portion that manages a reproduction order, etc., from the storage addresses of the chunks stored in the memory 104. The control unit 101 stores the created moov atom at the position following the mdat atom (S716). The control unit 101 closes the moving picture file in the MOV format opened for writing (S717) and settles the file to end the process.

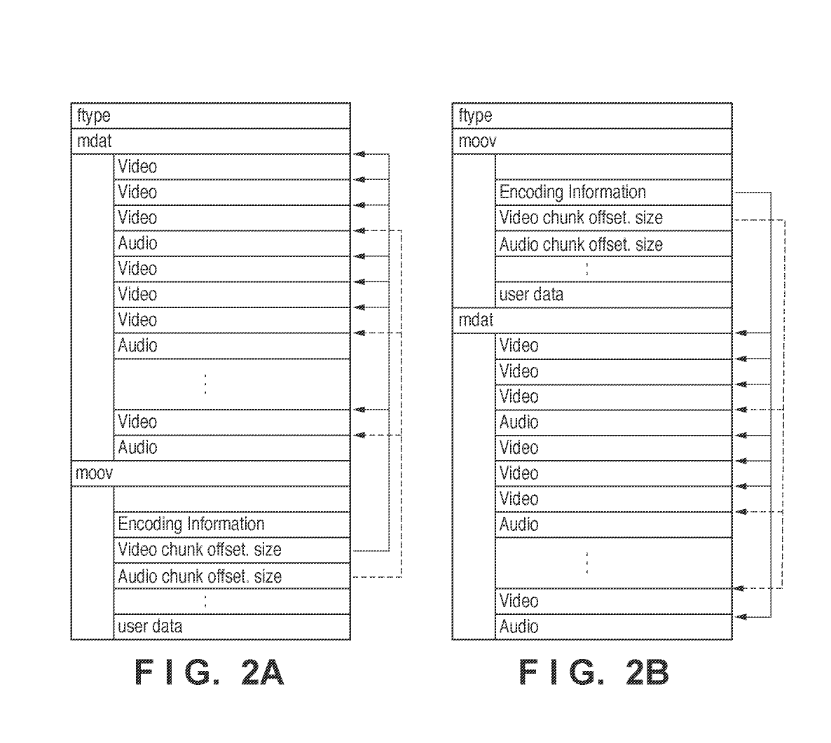

FIG. 2A shows an example of the data structure of the moving picture file in the MOV format created in the process of the embodiment. As shown in FIG. 2A, the data structure of the file is constituted in the order of ftype, mdat, and moov atoms. Detailed compatibility information (such as information of the recording device and software version) is recorded in the field “data” of the ftype atom, and the reproduction device can reference the content to simply determine whether the reproduction device can reproduce the MOV file (management information in moov needs to be referenced for detailed determination).

Media data, such as sample data of moving pictures and sound, is stored in the field “data” of the mdat atom. The media data is logically divided into data blocks called “chunks” and stored. Each chunk includes temporally continuous sample data, and an array of the chunks is stored in the field “data” of the mdat atom. The size of the chunks and the number of included samples are not particularly limited, and the chunks can have arbitrary sizes and numbers of samples. For example, moving picture data (Video) is recorded as 1 chunk=1 frame=1 sample, and audio data (Audio) is recorded as 1 chunk=sample data of a certain time. When one second of audio data that is sampled at 32 kHz is stored in one chunk, data of 32 k samples is stored. In the example of FIG. 2A, one audio data chunk is inserted every three moving picture data chunks.

Management information (metadata) of moving picture and sound samples is stored in the field “data” of the moov atom. Various atoms are actually stored in a nested structure in the field “data”, and various pieces of management information are stored. For example, a track atom that stores metadata information of data tracks in the MOV file is stored in the moov atom. Each data track is identified by a unique identifier called “track ID” in the MOV file, and the track atom records information related to the data tracks, such as the track IDs. Each chunk and sample described above belongs to one of the data tracks. Therefore, the metadata information of all chunks and samples constituting the data tracks is described in the track atom. In the case of FIG. 2A, there are tracks of moving picture data and audio data, and the metadata information is stored in each track atom. A Sample Description atom, a Sample Size atom, a Sample to Chunk atom, a Chunk Offset atom, etc. are stored in the fields “data” of the track atoms. Information for reproducing the track data is stored in the Sample Description atom. For example, encoding information, color information, etc., are stored for the moving picture data track, and encoding information, sample rate, etc., are stored for the audio data track. The size of each sample is stored in the Sample Size atom. For example, if the size of each sample (=each frame) is a variable length, the sizes of all samples are stored as an array for the moving picture data track. In the case of the audio data track, if the size of each sample is a fixed length such fact is recorded, and one fixed size is stored. The number of samples per chunk is stored in the Sample to Chunk atom. For example, information indicating that one sample (=one frame) is fixed to one chunk is stored for the moving picture data track. Information indicating that each chunk from the top chunk includes 3200 samples, and the twenty-fourth chunk includes 1070 samples per chunk is stored for the audio data track. In the Chunk Offset atom, an offset to the storage location of each chunk (offset from the top of the MOV file) is recorded, and the offsets are stored as arrays in the moving picture data track and the audio data track.

FIG. 2B shows another data structure of the moving picture file in the MOV format. As shown in FIG. 2B, the order of the mdat atom and the moov atom is opposite. It should be noted that the values of the recording positions of the chunks (offset values from the top of the file) need to be greater in FIG. 2B than in FIG. 2A by the amount of the moov atom size if the moving pictures reproduced by the two moving picture files are the same.

It could be understood from the description that the data structure shown in FIG. 2A is convenient for recording the photographed moving pictures. However, the configurations, locations, and sizes of the stored encoding information and chunks cannot be recognized just by mdat according to the data structure shown in FIG. 2A. Therefore, it can be understood that the information of moov is required to reproduce the MOV file.

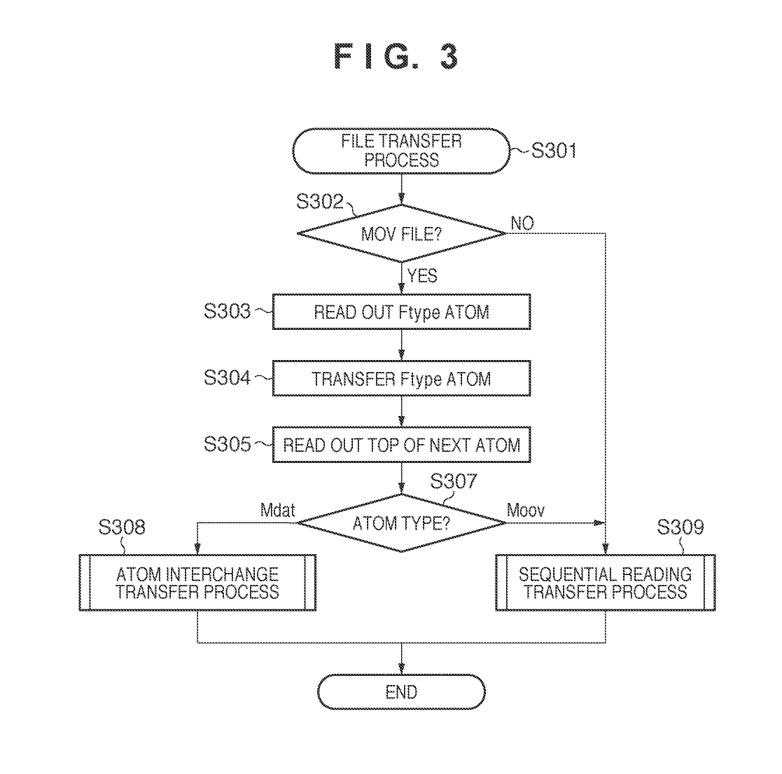

Processes when the image sensing apparatus of the present embodiment functions as a file server will be described with reference to flow charts of FIGS. 3, 4 and 5. The image sensing apparatus functions as a file server when the user operates a predetermined switch (button) of the operation unit 111, which is part of a process of S706 of FIG. 7.

When an instruction for functioning as a file server is received, the control unit 101 enables the wireless LAN device 108 to cause the image sensing apparatus to function as an FTP server. At this point, folders storing still image files and moving picture files of the memory card 106 and the HDD 107 are managed as folders accessible by an FTP client. A client terminal acquires a list of the files stored in the folders through the network, and when the user instructs a desired file, the client terminal requests a transfer request (RETR command in the FTP) of the file to the image sensing apparatus (file server). The transfer protocol and the designation method of file are examples. If there is a plurality of recording media as in the present embodiment, a file is designated along with the designation of a medium.

When a file transfer process is activated by receiving the file transfer request (S301), the control unit 101 determines whether the file requested from the client is a MOV file indicating moving pictures or a file (JPEG file) indicating still images (S302). Whether the file is a MOV file can be simply determined based on whether (.MOV) is used for the extension of the file of the file name. If the file is not a MOV file, i.e. if a still image file is designated, the control unit 101 proceeds to S309 to apply a “sequential reading transfer process” to the designated file and ends the process. The “sequential reading transfer process” is a typical file transfer process and is a process of sequentially repeating, up to the file end, reading out of the file from the top by a predetermined size and transferring the read data.

On the other hand, if the control unit 101 determines that the file requested for the transfer is a MOV file of moving pictures, the control unit 101 reads out an ftype atom recorded at the top of the file from the storage medium (the memory card 106 or the HDD 107 in the embodiment) storing the file, and temporarily stores the ftype atom in the memory 104 (S303). The control unit 101 transfers the read ftype atom to the client as a request source through the wireless LAN device 108 (S304). In the following S305, the control unit 101 reads out, to the memory 104, the top of the atom, which follows the ftype atom, by a predetermined size (for example, 1500 bytes, or at least 8 bytes including size and type of the list 1). The control unit 101 then checks the type field of the atom at the top of the read data (S307). More specifically, the control unit 101 determines whether the mov file requested for transfer has the data structure of FIG. 2A or the data structure of FIG. 2B. If the atom following the ftype atom is a moov atom, the data structure of the requested MOV file has an atom arrangement suitable for a receiving device. Therefore, the control unit 101 proceeds to S309 to execute a normal “sequential reading transfer process” and ends the file transfer process.

On the other hand, if the atom following the ftype atom is an mdat atom, the atom arrangement is not suitable for the receiving device. Therefore, the control unit 101 proceeds to S308 and executes an “atom interchange transfer process”.

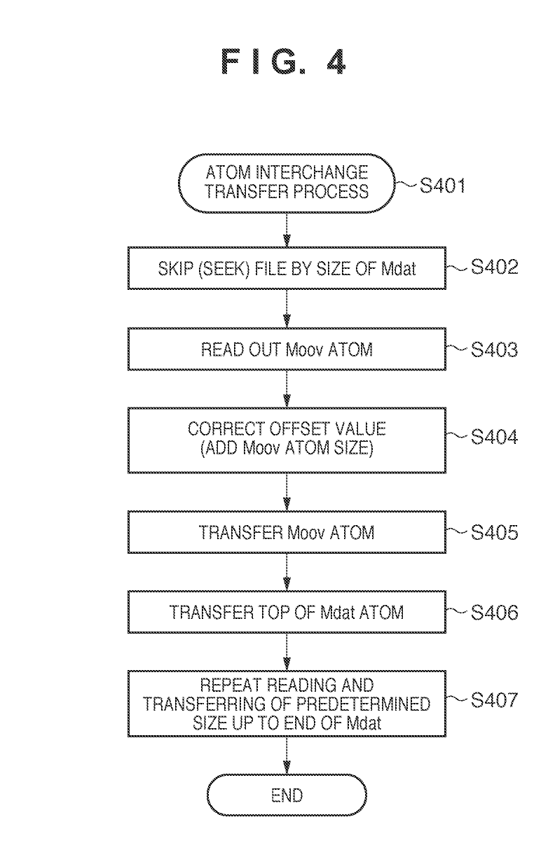

FIG. 4 is a flow chart showing details of the atom interchange transfer process of S308. The process will be described with reference to FIG. 4.

When the control unit 101 starts the atom interchange transfer process (S401), the control unit 101 first references the size field included at the top of the mdat atom read out to the memory 104 to acquire the size of the mdat atom. The control unit 101 advances the file reading position (file pointer) by the acquired size from the top of the mdat atom (S402). As a result, the file pointer seeks at the top position of the moov atom, and the moov atom is read out to the memory 104 from the file pointer position to the file end (S403). The read moov atom includes a Chunk Offset atom. As described above, the offset values to the chunks recorded in the atom are offset positions from the top of the file. As is clear from the description so far, the size of the moov atom needs to be added to the offset values to change the file configuration to bring the moov atom in front of the mdat atom. Therefore, the control unit 101 executes a correction process of updating and adding the Moov atom size to the entire array of the offset values recorded in the Chunk Offset atom read out to the memory 104 (S404). Thus, a new Moov atom is generated from the original Moov atom. The control unit 101 then sends the moov atom with corrected (generated) offset values to the client as the request source (S405).

From the client of the request source, it looks as if a MOV file in the format of FIG. 2B is received, because the client first receives the ftype atom and then receives the moov atom.

The control unit 101 transfers the top of the mdat atom already read out in S305 (S406) and continuously repeats sequential reading and transfer of the file data by the predetermined size up to the end of the mdat atom (S407). This completes the atom interchange transfer process.

When viewed from the client of the request source, a file in the format of FIG. 2B is received up to the end. Therefore, when the reception of the moov atom is completed, the client can reference the moov atom as necessary to start decoding and reproducing the mdat atom received subsequently. More specifically, the client can start reproducing the moving picture file without downloading the file up to the end.

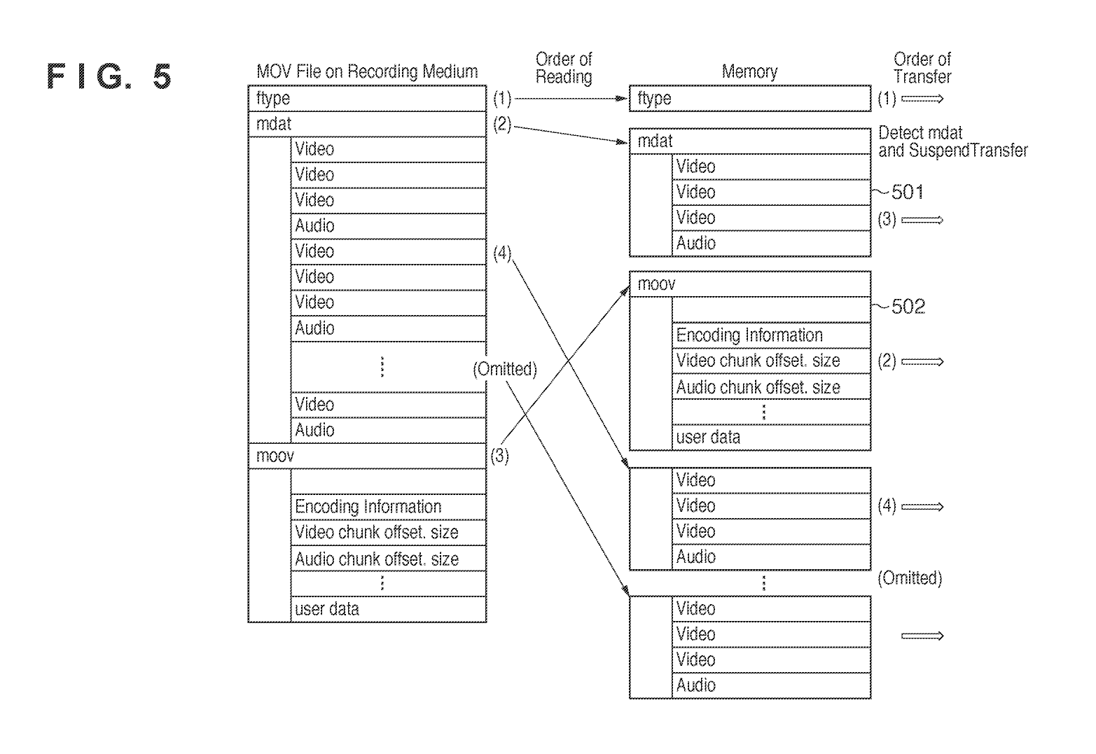

FIG. 5 shows a result of organizing the file reading of MOV file transfer and the order of transfer when the atom interchange transfer process is executed. The receiver as a request source receives the top of the mdat atom of reference numeral 501 after the moov atom of reference numeral 502. When the reception of the moov atom is completed, the receiver completes the reception of meta-information necessary for the reproduction and at least the top chunk of the moving picture data and the top chunk of the audio data. Therefore, the receiver can start reproducing the file while receiving the file.

In the description so far, reading of the file and transfer of the file are described as sequential processes for the simplification of the description. However, the transfer of the already read data and the following file data reading process may be executed in parallel (pipeline process) to reduce the processing time of the overall file transfer process.

As described, the data file transfer apparatus (image sensing apparatus) of the embodiment compatibly executes a process of interchanging the moov atom and the mdat atom in the file transfer process even in the case of the MOV file shown in FIG. 2A. Therefore, the receiving device can receive the MOV file in the format of FIG. 2B. The process of correcting the offset values (S404) in the atom interchange transfer process (FIG. 4) is a process of only adding a fixed value to the array of the offset values in the memory. Therefore, the process only requires a short time. The receiving device can start the reproduction while receiving the mdat atom. Therefore, the time between the instruction of the file transfer and the start of the reproduction is reduced, which is a great advantage for a user of the receiving device.

### Second Embodiment

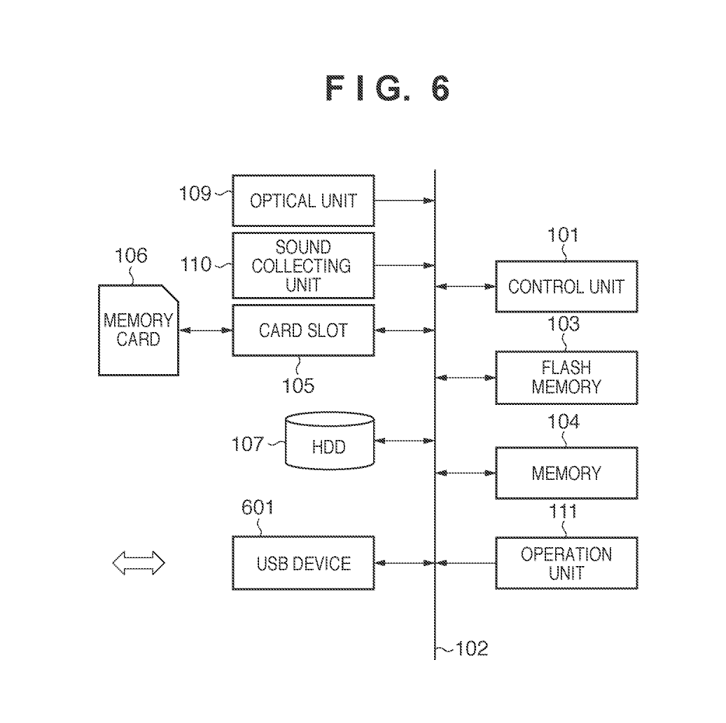

FIG. 6 shows a configuration of the data file transfer apparatus according to a second embodiment.

FIG. 6 is different in that a USB device 601 replaces the wireless LAN device 108 of FIG. 1. In the present second embodiment, an MTP (Media Transfer Protocol) is used as a protocol of the file transfer, and the communication processing and the protocol processing are realized as software (MTP responder) operated on the control unit 101. More specifically, an MTP initiator on an external device (including a USB host) connected through the USB requests the file transfer. In the MTP, GetObject designates an object ID to designate the file requested for the transfer. As in the first embodiment, the data file transfer apparatus of the present second embodiment that has received GetObject executes the file transfer process of FIG. 3 and the atom interchange transfer process of FIG. 4 as necessary. The same operation and effect as those in the first embodiment are attained.

### Third Embodiment

In the first and second embodiments, the file is rearranged and sent as shown in FIG. 2B if the requested moving picture file has a data structure of FIG. 2A. What should be noted here is that the update process of increasing the offset addresses of the chunks, which are managed in the field “data” of the original moov atom, by the size of the moov atom (field “size”) is applied to the moov atom to be sent to the receiving device. Therefore, the moov atom cannot be seamlessly sent after the transmission of the ftype atom because of the update process.

There can be two reasons for the receiving device to simply request for the moving picture file. One is to locally store and manage the file, and the other is to reproduce the file immediately after the reception. The atom interchange transfer process is not necessary in the former case, and it is better if the time required to complete the file transfer is shorter. In the latter case, it is desirable to transfer the file after the atom interchange transfer process as in the first embodiment.

First, the present third embodiment allows seamless transmission of the moov atom following the ftype atom. Second, whether the receiving device simply requests for the storage and management of the moving picture file or requests for the reception and reproduction is determined, and the atom interchange transfer process is executed only in the latter case.

The first task is the same as in the first embodiment if the MOV file is transferred first. The difference is that the moov atom with the updated chunk addresses created from the original moov atom upon the transfer is separately stored as an independent file, and the moov atom is used when a transfer request of the same file is received next time. The file name of the separately stored moov atom is the same as the file name of the original moving picture, and the moov atom is stored in the HDD 107 with an extension “.moov”.

For the second task, if the file name of the MOV file requested for the transfer is “M0001.MOV”, it is determined that the transfer request is intended for the storage. If immediate reproduction is intended, another extension “.PLAY” is added to the file name. Therefore, if a virtual file name “M0001.MOV.PLAY” is designated in the transfer request, it is determined that the transfer request is intended for immediate reproduction of the physical file name “M0001.MOV”, and the atom interchange transfer process is executed. In this way, just the file name is operated. Therefore, the file server can determine, without changing the existing protocol, whether the MOV file requested for the transfer is intended for the storage in a storage device (such as a hard disk) in the apparatus of the request source or intended for the immediate reproduction. It should be noted that the description above is just an example, because a character string can be used to discriminate part of the file name requested for the transfer. Not only the determination based on the file name, but also a protocol for determining, based on a request command, whether the transfer request is intended for the storage (such as a COPY command) or intended for the immediate reproduction (such as a PLAY command) can be used to solve the task.

The hardware configuration of the image sensing apparatus according to the present third embodiment is the same as that of the first embodiment, and an example for attaining the first and second tasks will be described.

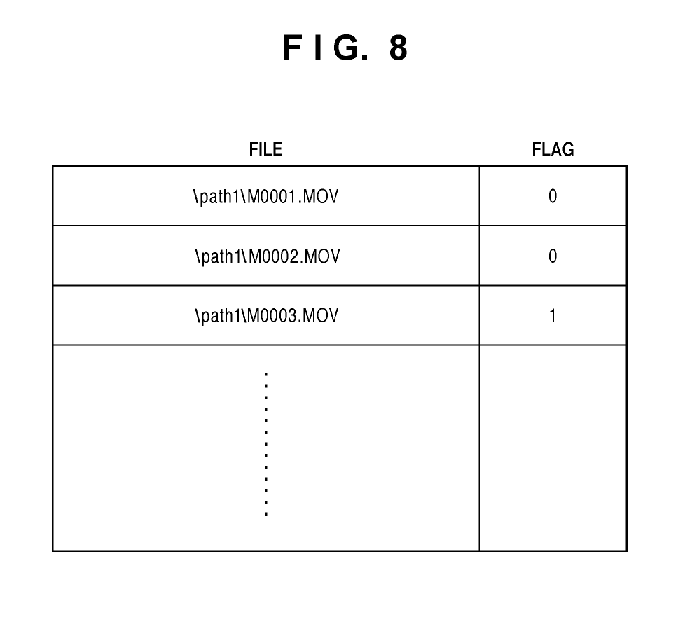

The control unit 101 according to the present third embodiment registers a file name with a path of a moving picture file in a management table as shown in FIG. 8 when moving pictures are taken and a MOV format file is recorded in the memory card 106 or the HDD 107. The management table is created in a preset area of the HDD 107 (or may be recorded as a management file). As shown in FIG. 8, the management table includes fields for storing file names with paths and fields for storing flags. The flag is used as information indicating whether the atom interchange transfer process is executed even once in the past. At the same time, the flag is used as information indicating whether the file of the moov atom exists. FIG. 8 is an example, and only the association of the moving picture file and the file of the moov atom is needed. Therefore the format is not limited to this. The control unit 101 sets “0” to the flag when moving pictures are newly taken, stored, and recorded, because the atom interchange transfer process is not executed. The control unit 101 sets “1” to the flag if the atom interchange transfer process is executed even once.

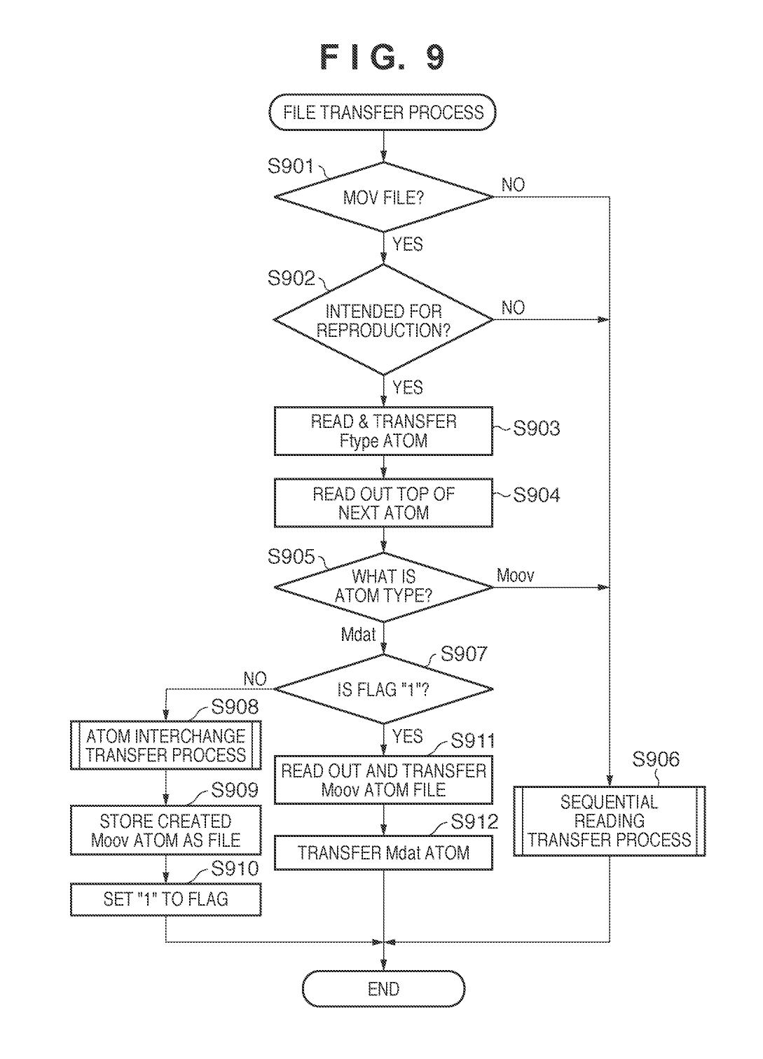

A file transfer process according to the present third embodiment will be described first with reference to a flow chart of FIG. 9. The flow chart of FIG. 9 replaces FIG. 3.

The control unit 101 determines whether a file requested from the client is a MOV file indicating moving pictures or a file (JPEG file) indicating still images (S901). Whether the file is a MOV file can be determined based on whether the character string of the extension of the file of the file name is “MOV” or “MOV.PLAY”. If the file is not a MOV file, i.e. if a still image file is designated, the control unit 101 proceeds to S906. The control unit 101 applies the “sequential reading transfer process” to the designated file and ends the process.

On the other hand, if the control unit 101 determines that the file requested for transfer is a MOV file of moving pictures, the control unit 101 determines whether the character string of the extension of the file is “MOV.PLAY” or “MOV” to determine whether the request is intended for the immediate reproduction (S902). If the control unit 101 determines that the request is not intended for the immediate reproduction, the control unit 101 proceeds to S906. The control unit 101 applies the “sequential reading transfer process” to the designated file even if the file is a moving picture file and ends the process. As a result, the atom rearranging process is not executed if the request is intended for the storage. Therefore, there is no hold time from the transfer of the ftype atom to the transfer of the moov atom, and the time required for the transfer can be reduced.

If the control unit 101 determines that the moving picture file requested for the transfer is intended for the immediate reproduction, the control unit 101 proceeds to the process to S903. In S903, the control unit 101 reads out the ftype atom recorded at the top of the designated moving picture file from the storage medium to temporarily store the ftype atom in the memory 104 and transfers the read ftype atom to the client as the request source through the wireless LAN device 108. In the following S904, the control unit 101 reads out the top of the atom following the ftype atom to the memory 104 by a predetermined size. The control unit 101 then checks the type field of the atom at the top of the read data (S905). Therefore, the control unit 101 determines which of the data structures of FIGS. 2A and 2B the MOV file requested for the transfer has. If the atom following the ftype atom is a moov atom, the data structure of the requested MOV file has an atom arrangement suitable for the receiving device. Therefore, the control unit 101 proceeds to S906 to execute the normal “sequential reading transfer process” and ends the file transfer process.

On the other hand, if the atom following the ftype atom is an mdat atom, the control unit 101 checks the table (see FIG. 8) to determine whether the flag of the moving picture file requested for the transfer is “0” or “1”. If the flag is “0”, the control unit 101 can determine that the moving picture file is for the first transfer intended for the immediate reproduction. Therefore, the control unit 101 executes the atom interchange transfer process (S908). The atom interchange transfer process is the same as that in FIG. 4 of the first embodiment, and the description will not be repeated. However, the moov atom after the update obtained from the original moov atom remains in the memory 104 even after the atom interchange transfer process. After the “atom interchange transfer process”, the control unit 101 stores, as an independent file, the updated moov atom held in the memory 104 in an unshared area preset in the HDD 107 (S909). The control unit 101 sets “1” to the flag of the file requested for the transfer in the management table to indicate the existence of the updated moov atom (S910) and ends the process.

On the other hand, if the control unit 101 determines that the flag is “1” in S907, the control unit 101 reads out the data of the moov atom from the file stored as a moov atom and transfers the data (S911). The control unit 101 then transfers the mdat atom requested for the transfer (S912).

According to the third embodiment described above, the moving picture file in the MOV format that has been requested for the transfer even once in the past for the reproduction can be transferred without a time difference between the atoms, as compared to the first and second embodiments. The atom rearranging process is not executed for the transfer request intended for the file storage. Therefore, a transfer in a short time is promised if the network traffic is ignored. Although an example for realizing the two tasks at the same time has been described in the third embodiment, only one of the tasks may be realized.

Although the management table is used to manage the presence of the moov file in the description, the moov file may be recorded in the same folder as the mov file, and the presence may be managed based on whether the moov file exists in the same folder.

Although an image sensing apparatus, such as a digital camera, has been illustrated as an example of the file server in the embodiments, the embodiments can be applied to a file server independent from a digital camera or a video camera. Therefore, the present invention is not limited by the embodiments.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-196096, filed Sep. 1, 2010, which is hereby incorporated by reference herein in its entirety.

What is claimed is:

1. A data file transfer apparatus comprising:
a communication unit that communicates with an external apparatus;
a storage unit that stores a moving picture file in a predetermined data structure, the file including a data portion with a structure of connected chunk data indicated by partially encoded data and including a management information portion that follows the data portion and indicates a reproduction order and storage addresses of the chunk data;
a reception unit that receives a transfer request of the moving picture file stored in said storage unit from the external apparatus through said communication unit; and
a transfer unit that transfers the moving picture file, which is reconfigured by interchanging the order of the data portion and the management information portion in the moving picture file requested for the transfer, to the external apparatus through said communication unit when said reception unit receives the transfer request, wherein
said transfer unit comprises:
a generating unit that generates a new management information portion by adding an offset corresponding to a size of the management information portion to the storage addresses of the chunk data stored in the management information portion in the moving picture file requested for the transfer; and
a sending unit that sends, as the management information portion in the moving picture file requested for the transfer, the new management information portion generated by said generating unit to the external apparatus and then sends the data portion.

2. The apparatus according to claim 1, wherein
the moving picture file in the predetermined data structure is a moving picture file in a MOV format or an MP4 format, the data portion is an mdat atom, and the management information portion is a moov atom.

3. The apparatus according to claim 1, further comprising
a management unit that handles the generated new management information portion as an independent file when said generating unit creates the new management information portion and stores the new management information portion in said storage unit in association with the moving picture file requested for the transfer, wherein
said transfer unit determines whether the file of the management information portion stored and managed in association with the moving picture file requested for the transfer exists in said storage unit and handles the data of the file of the management information portion as the new management information portion generated by said generating unit to transfer the data to the external apparatus if said transfer unit determines that the file of the management information portion exists in said storage unit.

4. The apparatus according to claim 1, further comprising
a determination unit that determines whether the transfer request received by said reception unit is a request for the moving picture file in the predetermined data structure, wherein
said transfer unit transfers the reconfigured moving picture file to the external apparatus if the result of the determination by said determination unit indicates a request for the moving picture file in the predetermined data structure and transfers the requested moving picture file without changing the data structure if the result does not indicate a request for the moving picture file in the predetermined data structure.

5. The apparatus according to claim 1, further comprising
a determination unit that determines whether the transfer request received by said reception unit is a request intended for immediate reproduction of the moving picture file in the predetermined data structure by the external apparatus, wherein
said transfer unit transfers the reconfigured moving picture file to the external apparatus if the result of the determination by said determination unit indicates a request intended for the immediate reproduction and transfers the requested moving picture file without changing the order of the data structure if the result does not indicate a request intended for the immediate reproduction.

6. The apparatus according to claim 1, further comprising:
an image sensing unit that takes a moving picture; and
a designation unit that designates whether to function as the data file transfer apparatus.

7. A control method of a data file transfer apparatus, the apparatus comprising: a communication unit that communicates with an external apparatus; and a storage unit that stores a moving picture file in a predetermined data structure, the file including a data portion with a structure of connected chunk data indicated by partially encoded data and including a management information portion that follows the data portion and that indicates a reproduction order and storage addresses of the chunk data, the control method comprising:
a reception step of receiving a transfer request of the moving picture file stored in said storage unit from the external apparatus through said communication unit; and
a transfer step of transferring the moving picture file, which is reconfigured by interchanging the order of the data portion and the management information portion in the moving picture file requested for the transfer, to the external apparatus through said communication unit when the transfer request is received in said reception step, wherein
said transfer step comprises:
a generation step of generating a new management information portion by adding an offset corresponding to a size of the management information portion to the storage addresses of the chunk data stored in the management information portion in the moving picture file requested for the transfer; and
a sending step of sending, as the management information portion in the moving picture file requested for the transfer, the new management information portion generated in said generation step to the external apparatus and then sending the data portion.

8. A non-transitory computer-readable storage medium storing a computer program read and executed by a computer to cause the computer to function as a data file transfer apparatus, the computer comprising:
a communication unit that communicates with an external apparatus; and
a storage unit that stores a moving picture file in a predetermined data structure, the file including a data portion with a structure of connected chunk data indicated by partially encoded data and including a management information portion that follows the data portion and that indicates a reproduction order and storage addresses of the chunk data,
wherein the computer program comprising steps of:
receiving a transfer request of the moving picture file stored in said storage unit from the external apparatus through said communication unit; and
transferring the moving picture file, which is reconfigured by interchanging the order of the data portion and the management information portion in the moving picture file requested for the transfer, to the external apparatus through said communication unit when the transfer request is received in said receiving, wherein
said transferring comprises steps of:
generating a new management information portion by adding an offset corresponding to a size of the management information portion to the storage addresses of the chunk data stored in the management information portion in the moving picture file requested for the transfer; and
sending, as the management information portion in the moving picture file requested for the transfer, the new management information portion generated in said generating to the external apparatus and then sending the data portion.
